(19) United States
(12) Patent Application Publication
(10) Pub. No.: US 2009/0187469 A1
(43) Pub. Date: Jul. 23, 2009

(54) METHOD FOR THE SIMULTANEOUS DIFFUSION OF SURVEY QUESTIONNAIRES ON A NETWORK OF AFFILIATED WEB SITES

(75) Inventors: Frank SMADJA, Haifa (IL); Frederic-Charles Petit, Paris (FR)

Correspondence Address: BROWDY AND NEIMARK, P.L.L.C.;624 NINTH STREET, NW, SUITE 300, WASHINGTON, DC, 20001-5303, US

(73) Assignee: Toluna, Levallois-Perret (FR)

(21) Appl. No.: 12/256,884

(22) Filed: Oct. 23, 2008

(30) Foreign Application Priority Data
Jan. 23, 2008 (FR) 08 00357

(51) Int. Cl. G06Q 10/00

(52) U.S. Cl. 705/10; 705/1

(57) ABSTRACT

The method according to the invention consists of dynamically adapting survey questionnaires to the content of the affiliated Web sites of editors and the specific visitors of said sites. It comprises the dynamic selection of the most appropriate questionnaire for a given survey in function of the content of the site of the editor and/or the specific who visits the Web site of the editor and/or the response rate to the questionnaire.

### BACKGROUND OF THE INVENTION

### Field of the invention

This invention relates to a method for the simultaneous diffusion of survey questionnaires on a network of affiliated Web sites.

It concerns the field of on-line targeted announcements and, but not exclusively, applies, to a particular type of announcements that can be used to carry out market surveys.

This type of announcement will be designated hereafter by the terms “survey questionnaires”. In its broadest sense and in the context of this application, a survey should be considered to be means which permit the opinions of a large number of on-line users to be collected. It may be presented in the form of a standard questionnaire wherein the users have to choose between several possible answers. However, it may also be designed so that it simply permits a user to give his/her opinion, knowledge, evaluation, etc. on any determined subject.

In its most general form, the survey questionnaire may consist of a announcement banner displayed on the screen and inviting the user to click on a sub-zone of the screen.

The owner of the Internet site or Blog on which the survey questionnaire is displayed is called “the editor”. The entity that wishes to carry out the market study is called “the advertiser” and the system which distributes or publishes simultaneously the survey questionnaires to the editors is called the “survey network”.

The invention is based on the idea that to provide a high CPM rate (cost per click, cost per thousand) for a simultaneous diffusion of survey questionnaires, these questionnaires must be of interest to the user answering the survey.

In the context of an affiliated network, the invention considers that the only way to achieve this result is by means of very dynamic adaptation of the survey questionnaire to the content of the editor and the specific visitor of site of the editor.

Consequently, for example, a survey questionnaire asking questions on the subject of driving preferences has a greater probability of obtaining a response if it is situated in a Blog concerning cars, and a very low probability of obtaining a response if it is situated in a Blog concerning animations.

### SUMMARY OF THE INVENTION

The invention permits this result to be obtained by means of a very dynamic selection method that selects the most appropriate questionnaire, for example the questionnaire with the highest hierarchical rating for a given survey based on the following elements:

The content of the Web site of the editor: this requires a dynamic reaction especially in the case of Blogs that may add new content several times a day.

The content of the survey questionnaires.

The specific user who visits the Web site of the editor if this user has already received a message (cookie) from the survey network.

The background of the user on the survey network: other survey questionnaires that have been answered, unanswered questionnaires, basic demographic information, interests, etc.

The response (click) rate: a survey questionnaire that does not get enough “clicks” is probably a survey questionnaire that is not correctly positioned. The invention proposes therefore to adapt the hierarchical rating in function of the validation (click) rate.

### BRIEF DESCRIPTION OF THE DRAWINGS

One application mode of the invention is described below, by way of non-restrictive example, in reference to the appended drawings in which:

FIG. 1 is a diagrammatical representation of a survey network;

FIG. 2 is a block diagram which illustrates the process of supplying a survey questionnaire whose rating is dynamically optimised.

### DESCRIPTION OF THE PREFERRED EMBODIMENTS

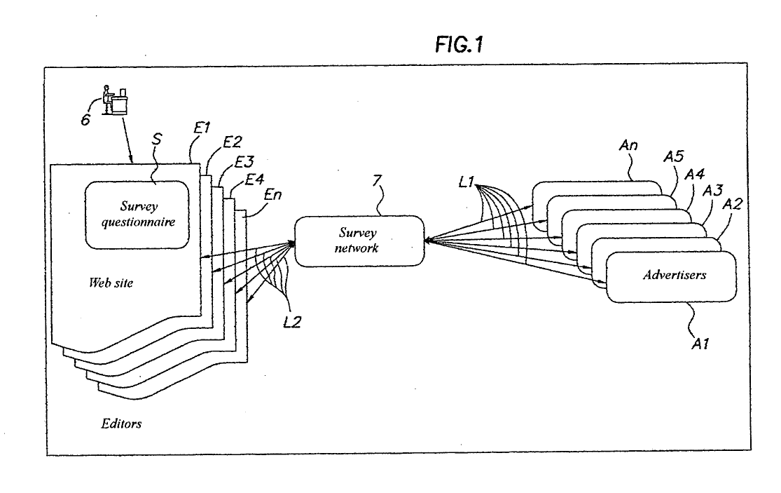

In the example shown in FIG. 1, the method according to the invention involves a plurality of Web sites E₁, E₂, E₃, E₄ . . . Eₙ each belonging to an editor. On each of these sites E₁, E₂, E₃, E₄ . . . Eₙ may be displayed a survey questionnaire S that is accessible by a user 6 who has a computer system (processor/keyboard/screen) connected to the network. The survey questionnaires S are distributed on the sites E₁, E₂, E₃, E₄ . . . Eₙ by means of a survey network 7, initiated by a plurality of advertisers A₁, A₂, A₃, A₄, A₅, Aₙ who wish to carry out market surveys.

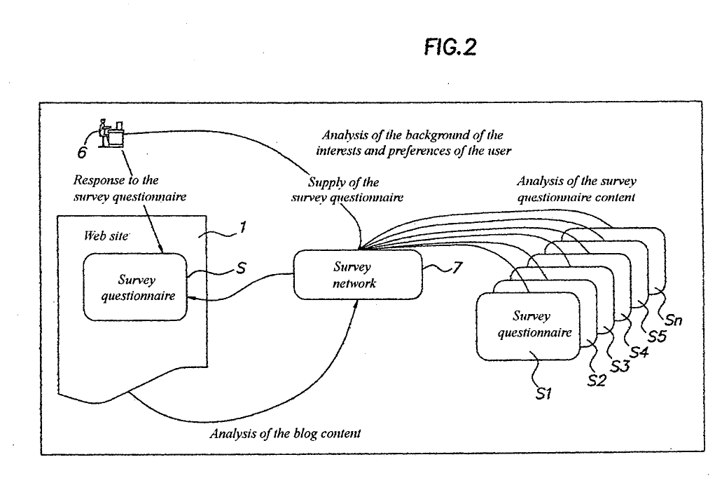

As illustrated in FIG. 2, the survey network 7 is designed so as:

To analyse the content of the survey questionnaires S₁, S₂, S₃, S₄, S₅, Sₙ issued by the advertisers A₁, A₂, A₃, A₄, A₅, Aₙ (L₁ connections),

To analyse the content of the Blogs of the editors (L₂ connections),

To analyse the background of the user 6, the behaviour and preferences of the latter, and

To provide the Web sites E₁, E₂, E₃, E₄ . . . Eₙ of the editors a survey questionnaire that is dynamically optimised in function of the results of said analyses.

This solution especially permits a higher CPM rate (cost per click, cost per thousand) to be obtained, especially thanks to:

More appropriate linking between the interests of the user and the content of the survey questionnaire displayed by the editor,

Totally dynamic hierarchical rating that is adapted to the new content,

Totally dynamic hierarchical rating that is adapted to the flow or the response (click) rate.

The method described above may be implemented as follows:

The entity that is interested by a market survey pays to place survey questionnaires.

The editors concerned then supply the survey network with free space on their respective Web sites E₁, E₂ . . . Eₙ or their Blogs.

The survey network 7 will then place the survey questionnaires on the free spaces of the sites of the editors E₁, E₂ . . . Eₙ by using the hierarchical rating process described above.

One application mode of the hierarchical rating process is described below:

Initially, a clustering algorithm is used, such as the K-means method, the EM algorithm or the main component analysis to distribute the editors in function of the content of their sites E₁, E₂ . . . Eₙ. This “clustering” may use the content of the sites E₁, E₂ . . . Eₙ as well as meta-information in the form of notes, anchor texts and cross references.

Hierarchical rating is used for the questionnaires S₁, S₂ . . . Sₙ for each cluster and the best survey questionnaires are determined for each cluster.

The hierarchical rating is adapted for each pair [survey questionnaire/site] based on the response rate (click rate) to the questionnaire on the specific site.

The hierarchical rating is finally adapted for each pair [visitor, questionnaire] in function of the background of the user with the survey network.

1. Method for optimising the diffusion of survey questionnaires on a network of affiliated editor Web sites consisting of dynamically adapting the survey questionnaires to the content of said sites and to the specific visitors of said sites.

2. Method according to claim 1 comprising the dynamic selection of the most appropriate questionnaire for a given survey, in function of:
the content of the Web site of the editor, and/or
the content of the survey questionnaires, and/or
the specific user who visits the Web site of the editor, and/or
the response rate to the questionnaire.

3. Method according to claim 2 wherein the most appropriate questionnaire consists in that which has the highest hierarchical rating.

4. Method according to claim 2, wherein said selection is made in function of the background of the user with the affiliated network.

5. Method according to claim 2, wherein said selection is made in function of the response rate to the questionnaire.

6. Method according to claim 1, comprising the following steps following a request for a market survey by an entity:
the supply by the editors concerned to a survey network of free space on their respective Web sites Web or Blogs,
the placing by the survey network of questionnaires in the free spaces of the editor sites according to a hierarchical rating process.

7. Method according to claim 6, wherein the hierarchical rating process comprises the following steps:
the creation of clusters of editors in function of the content of their sites,
the hierarchical rating of the survey questionnaires for each cluster and the determination of the most appropriate questionnaires for each cluster,
the adaptation of the hierarchical rating for each questionnaire/site pair, based on the response rate to the questionnaire on the specific site,
the adaptation of the hierarchical rating for each [visitor/questionnaire] pair based on the background of the contacts between the user and the survey network.
